(19) United States
(12) Patent Application Publication
(10) Pub. No.: US 2011/0273280 A1
(43) Pub. Date: Nov. 10, 2011

(54) MEDICAMENT REMINDER DEVICE

(76) Inventors: Han Chao Chang, Tainan (TW); Jen Lin Chen, Cupertino, CA (US)

(21) Appl. No.: 12/377,878

(22) PCT Filed: Sep. 4, 2007
(86) PCT No.: PCT/US07/19265

§ 371 Date: Feb. 18, 2009

(30) Foreign Application Priority Data
Sep. 5, 2006 (DE) 202006013749.1

(51) Int. Cl. G08B 1/00

(52) U.S. Cl. 340/309.7

(57) ABSTRACT

A medicament reminder device for reminding patients to ingest or administer medicaments includes an output (3) assembly operable to generate a reminder signal (14), and to generate messages of pieces of information associated respectively with the medicaments (3), and a timer (100) electrically coupled to the output assembly (3) and operable to store a plurality of reminder moments (120), each of the reminder moments (102) being associated with at least one of the medicaments (18) and corresponding pieces of information, the timer (100) controlling the output assembly at each of the reminder moments (120) to generate the reminder signal, and to generate the messages with respect to the pieces of information corresponding to the at least one of the medicaments (18)

### CROSS-REFERENCE TO RELATED APPLICATION

This application claims priority of German Application No. 202006013749.1, filed on Sep. 5, 2006.

### BACKGROUND OF THE INVENTION

1. Field of the Invention

The present invention relates to a device for reminding patients to take or administer medicaments. More particularly, the present invention relates to a medicament reminder device that includes a programmable timer capable of performing control to remind patients to take or administer a plurality of medicaments that may have different dosage regimens.

2. Description of the Related Art

Many patients require the ingestion or administration of medicaments at regular intervals to treat their illnesses. To optimize medicinal efficacy, it is necessary to take or administer medicaments as prescribed by a medical professional, which typically entails ingestion or administration at specific times. For example, a prescription for a particular medicament may require a patient to take or administer the medicament several times a day every certain number of hours. As another example, it may be required to take or administer a certain medicament once a day at a fixed time during the day, and over a period of several weeks.

For many patients, it is difficult to adhere precisely to their medication regimens. This is particularly true for patients that must concurrently take different medicaments with dissimilar ingestion or administration time cycles and dosage amounts. Furthermore, the complexity of such a medication regimen becomes quite challenging for some elderly patients. For many obvious reasons, it is not desirable to improperly (or fail to) ingest or administer medicaments.

To overcome the problems as outlined above, devices that remind patients to ingest or administer medicaments have been disclosed. However, a drawback of such prior art devices is that they are designed to monitor the ingestion or administration of one medicament only. Also, these prior art devices have only the basic function of outputting a sound alarm at the programmed times.

### SUMMARY OF THE INVENTION

Therefore, the object of this invention is to provide a medicament reminder device for reminding patients to take or administer medicaments, in which the medicament reminder device may reliably provide reminders for the ingestion or administration of medicaments, even when several different medicaments must be taken or administered concurrently in different dosage amounts and at different times.

The medicament reminder device of this invention includes an output assembly operable to generate a reminder signal and to generate messages of pieces of information associated respectively with the medicaments, and a timer electrically coupled to the output assembly and operable to store a plurality of reminder moments.

Each of the reminder moments is associated with at least one of the medicaments and corresponding pieces of information. The timer controls the output assembly at each of the reminder moments to generate the reminder signal, and to generate the messages with respect to the pieces of information corresponding to the at least one of the medicaments.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of medicament reminder device according to a preferred embodiment of the present invention;

FIG. 2A is a schematic front view of an exemplary embodiment of the medicament reminder device of the present invention;

FIG. 2B is a schematic rear view of the medicament reminder device of FIG. 2A;

FIG. 2C is a perspective view of the medicament reminder device of FIG. 2A;

FIG. 3 is a perspective view of another exemplary embodiment of the medicament reminder device of the present invention;

FIG. 4 is a flow chart of steps involved in programming a timer of the preferred embodiment;

FIG. 5 is a flowchart of steps involved in a watchdog process of the preferred embodiment; and

FIG. 6 is a flow chart of steps involved in termination of the watchdog process of the preferred embodiment.

### DETAILED DESCRIPTION OF THE PREFERRED EMBODIMENT

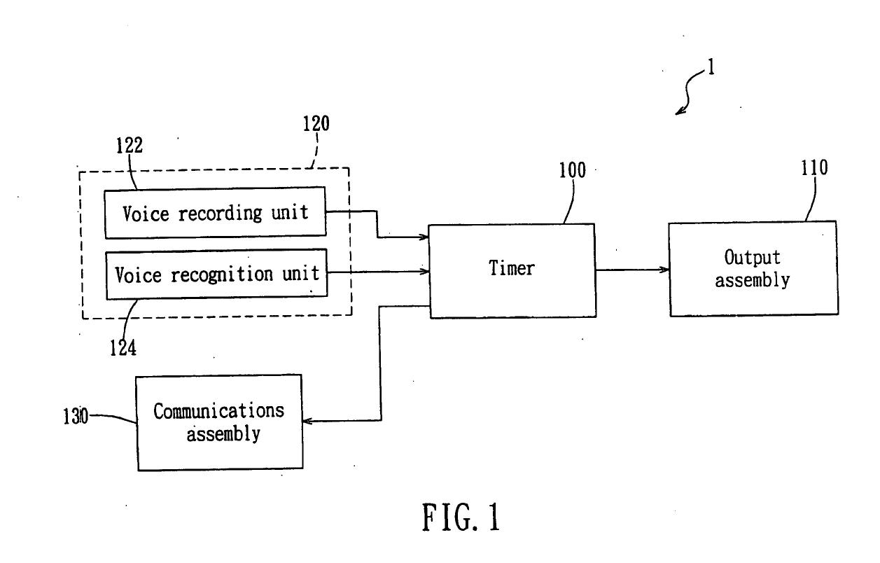

Referring to FIG. 1, a medicament reminder device 1 according to a preferred embodiment of the present invention includes a timer 100, an output assembly 110, an input assembly 120, and a communications assembly 130. The timer 100 is electrically coupled to each of the output assembly 110, the input assembly 120, and the communications assembly 130.

The timer 100 is operable to store a plurality of reminder moments, in which each of the reminder moments is associated with at least one medicament, where “medicament” may refer to a single medicament or a plurality of medicaments. That is, medicaments have associated therewith specific dosage regimens. The timer 100 may be programmed (to be described hereinbelow) such that a patient is reminded to ingest or administer a plurality of medicaments according to their dosage regimens. To allow such operation, the timer 100 may be, for example, a microcontroller having a memory (both not shown). Each of a plurality of times at which a medicament is to be ingested or administered is programmed into the timer 100 to become a reminder moment. Since the times of ingestion or administration of two or more medicaments can coincide, a single reminder moment may be associated with more than one medicament. In the preferred embodiment, the timer 100 may be further programmed with information of each medicament. For example, the name and dosage amount of each medicament may be programmed into the timer 100. To aid in the description of the present invention, information associated with a single medicament is referred to hereinafter as a piece of information.

The timer 100 controls the output assembly 110 at each reminder moment to generate a reminder signal, and to generate a message corresponding to a piece of information of a medicament associated with the reminder moment. If more than one medicament is associated with the reminder moment, the timer 100 controls the output assembly 110 to generate a message for each of the pieces of information of each of the medicaments.

A prescription period may be further associated with each of the medicaments. The prescription period is a time period during which a medicament is to be ingested or administered. When a prescription period for a medicament is programmed into the timer 100, the timer 100 discontinues control of the output assembly 110 to generate the reminder signal and the message associated with the piece of information with respect to the medicament when the prescription period thereof has elapsed.

The input assembly 120 allows user input of the reminder moments, the pieces of information associated with the medicaments, and the prescription periods associated with the medicaments. In this embodiment, the input assembly 120 include's a voice recording unit 122 and a voice recognition unit 124. The voice recording unit 122 is operable to record a user's voice with respect to the messages of the pieces of information associated with the medicaments, and the output assembly 110 is operable to play back the recorded messages. The voice recognition unit 124 allows user input to be performed vocally.

The communications assembly 130 is operable to transmit transmission signals to a predetermined terminal within a communications network so as to effect generation of the reminder signals by the predetermined terminal. The communications assembly 130 may be further operable to transmit the messages to a predetermined terminal within a communications network. In one embodiment, the communications network may be a telecommunications network. In another embodiment, the communications assembly 130 utilizes a mobile communications access technology to transmit the reminder signals and the messages. Each of the transmission signals may effect generation of a reminder signal by the predetermined terminal in the form of a voice message, such as: “It is 9 o'clock. It is time to take two tablets of medicament XY.” Alternatively, each of the transmission signals may effect generation of a reminder signal by the predetermined terminal in the form of a short text message conveying information substantially along the lines of the above exemplary voice message. With the provision of this function, there is no need for the user to carry or be at the vicinity of the medicament reminder device 1 to be reminded of ingesting or administering the medicaments. The user need only carry his or her medicaments when leaving the location where the medicament reminder device 1 is placed.

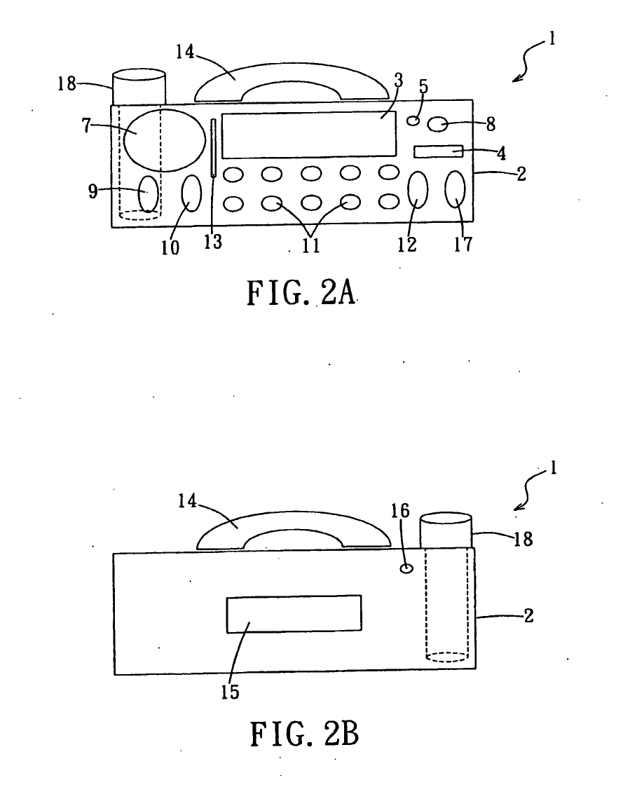

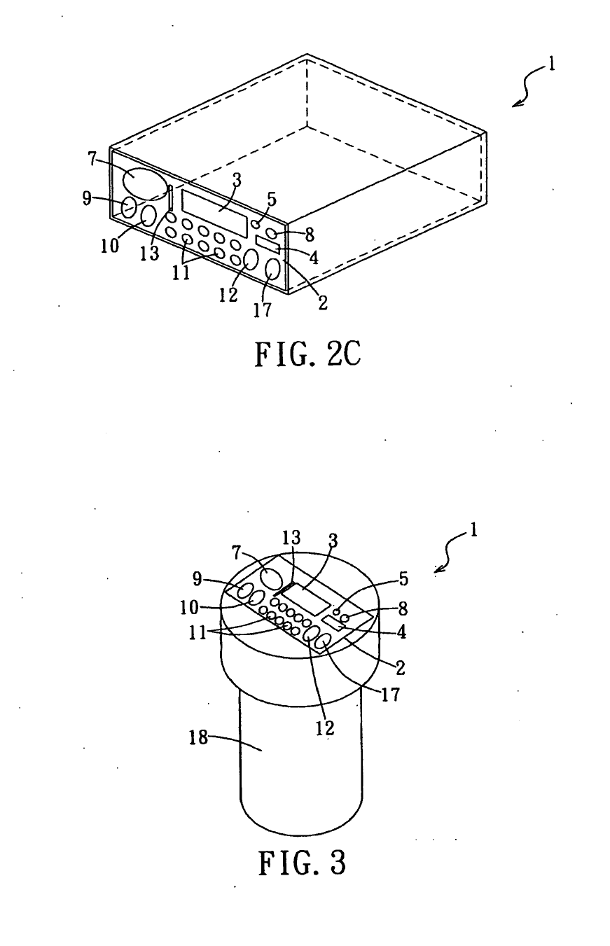

FIGS. 2A-2C and FIG. 3 show different exemplary embodiments of the medicament reminder device 1 of the present invention described above.

Referring first to FIGS. 2A-2C, the medicament reminder device 1 of this embodiment includes a casing 2, a display unit 3, a micro-motor 4, a light 5, a speaker 7, a mute key 8, a voice control key 9, an acknowledgement key 10, ten numerical keys 11, an enter key 12, an antenna 13, a holder 14, a power supply unit 15, a reset key 16, a cancel key 17, and a receptacle 18. Not all the elements are shown in each of FIGS. 2A-2C.

The display unit 3 is received in and at least partially exposed from the casing 2. In this embodiment, the display unit 3 is a liquid crystal display. In some embodiments, the display unit 3 may be a liquid crystal display having touchscreen capabilities so that the user may perform input via the display unit 3. The display unit 3 displays the messages of the pieces of information associated respectively with the medicaments. Display may be in a text or image format. The display unit 3 may also display text and images for programming the timer 100 (to be described below), as well as the current time.

The micro-motor 4, the light 5, and the speaker 7 are used to generate the reminder signal in different forms. That is, the micro-motor 4 generates the reminder signal in the form of a vibratory signal, the light 5 generates the reminder signal in the form of a visual signal, and the speaker 7 generates the reminder signal in the form of an auditory signal. The vibratory signal is advantageous in situations, for example, where signaling is to be effected without perception by others. As for the auditory signal, different tones may be allocated to the different medicaments to be ingested. In this embodiment, the light 5 is a light-emitting diode, and may be controlled to generate the visual signal in a flashing or continuously-on manner. A voice output can be effected through the speaker 7. The speaker 7 may also function as a microphone for voice recording.

The display unit 3, the micro-motor 4, the light 5, and the speaker 7 constitute the output assembly 110 in this embodiment.

The mute key 8 may be manipulated to activate or deactivate the auditory signal output by the speaker 7, in which case only the vibratory signal of the micro-motor 4 and the visual signal of the light 5 remain activated. The voice control key 9 may be manipulated by the user to activate or deactivate voice output through the speaker 7. The acknowledgement key 10 may be manipulated by the user to confirm the ingestion or administration of medicaments in response to the reminder signal. In this embodiment, the timer 100 of the medicament reminder device 1 generates the reminder signal until the acknowledgement key 10 is actuated. The ten numerical keys 11 serve as means to enter reminder moments, dosage date, and other data. The enter key 12 may be actuated to confirm entries, i.e., to provide a confirmation in the positive. Further, the cancel key 17 may be actuated to cancel entries, i.e., to provide confirmation in the negative.

When programming the timer 100 of the medicament reminder device 1, relevant query texts are displayed through the display unit 3. Alternatively, it is possible to issue questions on enterable data as a voice output through the speaker 7. The user enters answers through the numerical keys 11, and confirms each entry by manipulating the enter key 12. In some embodiments, the user may enter answers and perform confirmation through the speaker 7 for voice recognition processing by the voice recognition unit 124 of the input assembly 120.

The reset key 16 is disposed on a rear portion of the casing 2 of the medicament reminder device 1. By actuating the reset key 16, all data entered by the user and stored in the medicament reminder device 1 are deleted, and default settings are restored. The reset key 16 is typically depressed when desiring to program the timer 100 from anew.

Constituting the input assembly 120 in this embodiment, in addition to the voice recording unit 122 and the voice recognition unit 124 described above, are the speaker 7 (when functioning as a microphone), the mute key 8, the voice control key 9, the acknowledgement key 10, the numerical keys 11, the enter key 12, the reset key 16, and the cancel key 17. In embodiments where the display unit 3 has touchscreen capabilities as described above, the display unit 3 may also form part of the input assembly 120. The antenna 13 is used by the communications assembly 130 to transmit the reminder signal to a predetermined terminal within a communications network as described above.

The holder 14 is disposed on the casing 2 for releasably securing a package containing the medicaments to the medicament reminder device 1. In this embodiment, the holder 14 is an elastic strip. In another embodiment, the holder 14 may be realized through two strip pieces employing hook and loop fasteners. The medicament reminder device 1 may further or alternatively include the receptacle 18 for accommodating the medicaments. Through the use of the holder 14 and/or the receptacle 18, the medicaments may be kept with the medicament reminder device 1. This reduces the risk of losing the medicaments, and enhances convenience in that the user does not have to search for and retrieve the medicaments each time a reminder moment is encountered.

The power supply unit 15 is disposed in the rear portion of the casing 2 of the medicament reminder device 1. The power supply unit 15 includes one or more primary or secondary batteries (not shown) for use as a power supply for the medicament reminder device 1.

Referring now to FIG. 3, another exemplary embodiment of the medicament reminder device 1 is shown. In this embodiment, the electronic components of the medicament reminder device 1 are shown directly incorporated into a cap of a medicine bottle. Further, in comparison to the previously described exemplary embodiment (see FIGS. 2A-2C), the tube portion of the medicine bottle functions as the receptacle, and the holder 14 is omitted from the configuration.

Therefore, it is evident from the above that the securing relation between the electronic components and the container to hold medicaments of the medicament reminder device 1 may be fixed or detachable in nature. It is further evident that the size and shape of the container to hold medicaments relative to the electronic components of the medicament reminder device 1, as well as the relative positioning between the container to hold medicaments and the electronic components of the medicament reminder device 1 may be varied as desired and required. For example, the electronic components of the medicament reminder device 1 may be extremely small and incorporated into a removable cap of a medicine bottle as described in the embodiment of FIG. 3.

Additionally, although not shown, the medicament reminder device 1 may be further embodied in a base, etc. that includes an elastic band, a snap ring, and/or a hook-and-loop fastener so that the medicament reminder device 1 can be releasably secured to many different objects and at many different locations.

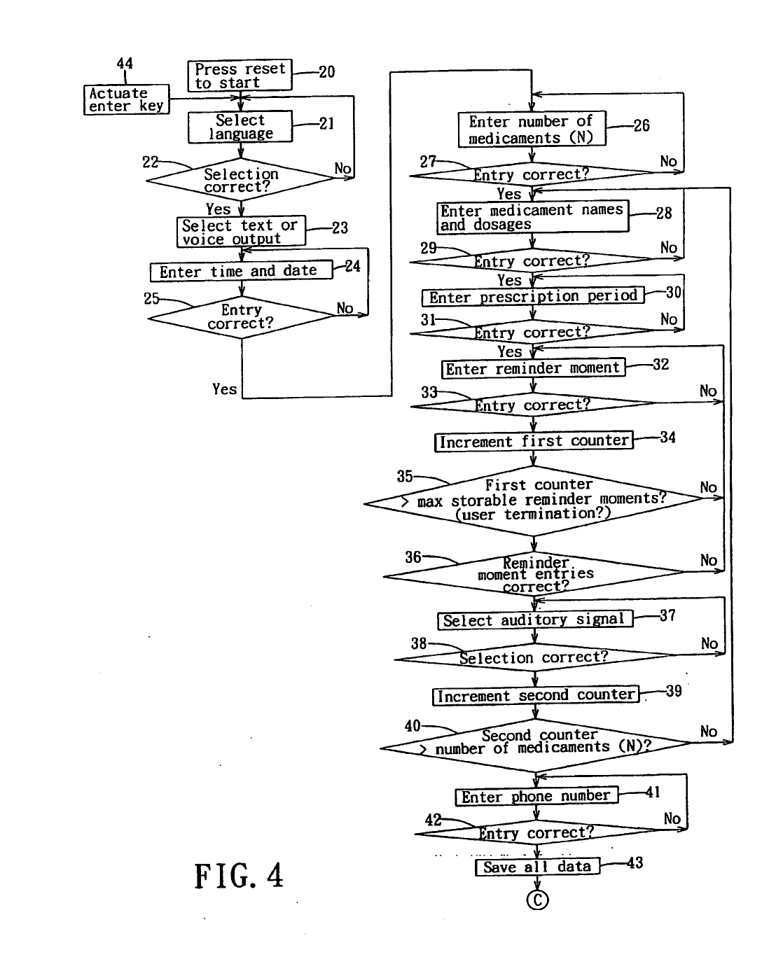

Referring to FIG. 4, steps involved in programming the timer 100 of the medicament reminder device 1 will now be described. The exemplary embodiments of FIGS. 2A-2C and 3 will be used to describe the programming of the timer 100. The programming of the timer 100 commences upon actuation of the reset key 16 by the user in step 20. Subsequently, in step 21, the user is prompted to select a language from the plurality of various languages. Once the user has selected a language, text and/or voice output in the selected language is effected via the display unit 3 and/or the speaker 7 in step 22. The user can confirm the accuracy of this output by entering “yes” or “no” (i.e., by actuating the enter key 12 or the cancel key 17) depending on whether or not the language has been correctly selected. All subsequent confirmations are performed in the same manner, i.e., user confirmation of a new entry is made by actuating the enter key 12 or the cancel key 17. Further, unless otherwise specified, the previous step is repeated if the user provides confirmation in the negative. If the language has not been correctly selected, step 21 is repeated. If the choice of language is correct, the user is prompted to select one of text or voice output in step 23. Next, in step 24, the user is prompted to enter the current time and/or date. This entry is succeeded by a request for confirmation of the accuracy of the newly input entry of the time and/or date in step 25.

Next, in step 26, the user is prompted to enter a number of medicaments (N), the ingestion or administration of which is to be reminded of by the medicament reminder device 1. For this example, it is assumed that the number of medicaments (N) is two or greater. In some embodiments, there may be only one of the medicaments (N). After the user enters a number, the user is requested to confirm the accuracy of this newly input entry in step 27. Input of the number of medicaments (N) at this time may be performed using suitable elements forming the input assembly 120. For example, the user may perform voice input via the speaker 7 for processing by the voice recognition unit 124. In step 28, the user is prompted to enter the name and dosage of each of the individual medicaments, the total number (N) of which has been entered in step 26. User input at this time may be performed by voice input via the speaker 7 for recording by the voice recording unit 122 of the input assembly 120. Next, in step 29, the user is requested to confirm the accuracy of these newly input entries of the name and dosage of each of the medicaments. Assuming voice input in step 28, reproduction of what the user vocally input is performed in step 29 for confirmation.

Next, in step 30, the user is prompted to enter the prescription period in step 30. Here, the user specifies the number of days that the reminder moments for taking the medicaments are to be output by the medicament reminder device 1. Subsequently, the user is requested to confirm the accuracy of this newly input entry in step 31.

In step 32, the user is prompted to enter a reminder moment specified by hour and minutes for one of the medicaments. Next, the user is requested to confirm the accuracy of this newly input entry in step 33. A first counter is incremented in step 34. In step 35, it is determined if the first counter exceeds a maximum possible number of storable reminder moments (e.g., 24). If not, steps 32, 33, 34, and 35 are repeated. These steps are designated by a bracket to indicate the steps involved in checking if the maximum possible number of storable reminder moments has been reached. This repetition is continued until the user terminates further entry of the reminder moments or until the maximum possible number of storage reminder moments has been reached. Next, the user is requested to confirm the accuracy of the newly input reminder moment entries in step 36. Confirmation at this time may be performed through voice playback of all the data entered by the user.

In step 37, the user is prompted to select the auditory signal to be used as the reminder signal for the medicaments. In step 38, the user is requested to confirm the accuracy of the auditory signal selection. In step 39, a second counter is incremented. In step 40, it is determined if the second counter exceeds the number of the medicaments (N) entered by the user in step 26. If not, the process is repeated starting from step 28.

If it is determined in step 40 that the second counter exceeds the number of the medicaments, that is, when reminder moments have been entered for all the medicaments, the user is prompted to enter a phone number in step 41 that is used for transmission of the reminder signals. Next, in step 42, the user is requested to confirm the correctness of the entered phone number. If the user confirms that the entered phone number is correct, the process ends with the saving of all confirmed data in the memory of the medicament reminder device 1 in step 43.

It is possible to restart the entry procedure again without having to actuate the reset key 16. For example, the medicament reminder device 1 may be configured so that actuation of the enter key 12 anytime subsequent to step 43 allows for the addition of further medicaments with corresponding reminder moments in step 44. Although actuation of the enter key 12 subsequent to step 43 is shown as restarting the process at step 21, it is also possible for the process to be restarted at step 26.

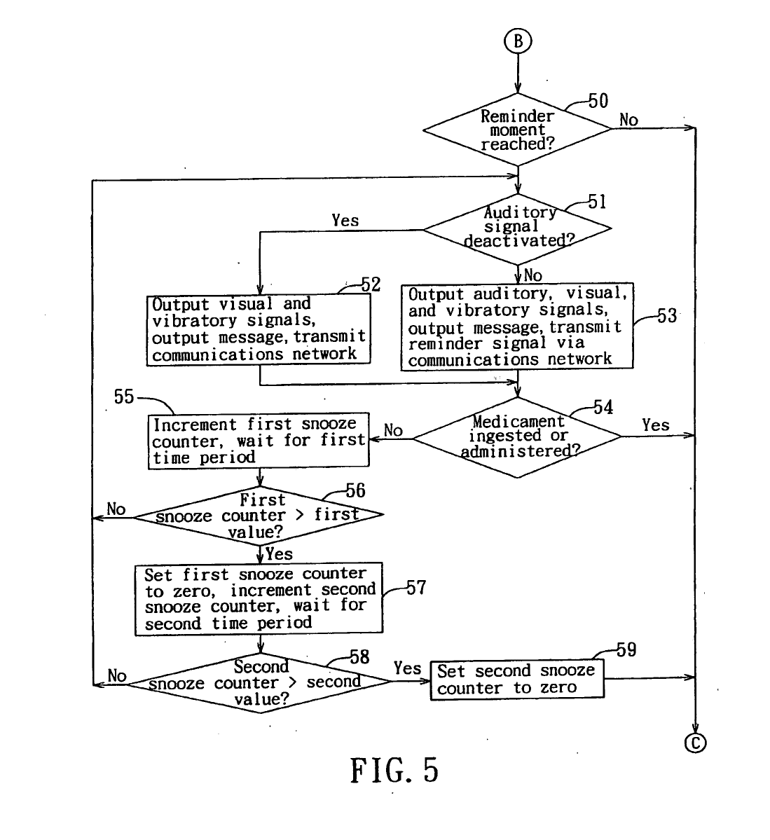

Following the completion of entering all the data, the time monitoring process (“watchdog”) begins. The steps involved in the watchdog process are shown in FIG. 5.

In step 50, the current time is continuously compared with the stored reminder moments. This comparison is repeated until there is correspondence between the current time and a reminder moment, at which point the flow goes to step 51.

In step 51, it is determined if the auditory signal through the speaker 7 has been deactivated by user manipulation of the mute key 8. If the auditory signal has been deactivated, only the visual signal of the light 5 and the vibratory signal of the micro-motor 4 are output as a reminder signal in step 52. Also in step 52, information concerning the medicament to be ingested or administered (i.e., the message of the piece of information associated with the medicament) is output through the display unit 3, and the phone number entered by the user is dialed and the reminder signal is transmitted via the phone connection. If the auditory signal has not been deactivated, in addition to the above, the auditory signal pre-selected for the relevant medicament is output through the speaker 7 in step 53.

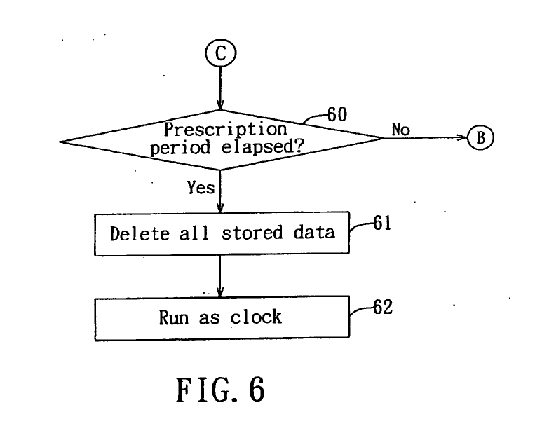

Next, in step 54, the user is requested to provide confirmation of whether the medicament has been ingested or administered, which the user provides by actuating the acknowledgement key 10. If the user provides confirmation, the process is directed to the steps of FIG. 6 which will be described below. However, if the user provides no confirmation, the process waits for a first predetermined time period and a first snooze counter is incremented by one in step 55. When the first predetermined time period of step 55 has elapsed, it is determined in step 56 if the first snooze counter exceeds a first predetermined value (e.g., three). If not, the process returns to step 51 and a reminder signal is again generated in either step 52 or 53, after which the process continues to step 54. If the first snooze counter exceeds the first predetermined value, however, the first snooze counter is set to zero, a second snooze counter is incremented by one, and the process waits for a second predetermined time period (e.g., 30 minutes) in step 57. In step 58, it is determined if the second snooze counter exceeds a second predetermined value (e.g., two). If not, the process is repeated starting from step 51. However, if the second snooze counter exceeds the second predetermined value, the second snooze counter is reset to zero in step 59, after which the process is directed to the steps of FIG. 6 which will be described below.

It is to be noted that a plurality of the above watchdog processes, each corresponding to a unique reminder moment, may be performed concurrently through use of interrupts. Since techniques related to the use of interrupts are well known, those skilled in the art will appreciate how a plurality of the watchdog processes may be performed simultaneously. Hence, a detailed description of the use of such interrupts to allow the simultaneous running of two or more watchdog processes will not be provided herein for the sake of brevity.

FIG. 6 shows steps involved in the termination of the watchdog process. In step 60, it is determined if the prescription period has elapsed. If not, the process is directed to the steps of the watchdog process of FIG. 5. If the prescription period has elapsed, however, all stored data are deleted in step 61. Subsequently, in step 62, the medicament reminder device 1 functions as a simple clock. It is to be noted that this process may include a verification step of determining if the prescription periods for all the medicaments have elapsed prior to deleting data in step 61. For example, a counter may be incremented and compared with the number of the medicaments (N) each time it is determined that the prescription period for a particular medicament has elapsed.

It is evident from the above description that the medicament reminder device 1 of the present invention may reliably provide reminders for the ingestion or administration of medicaments, even when several different medicaments must be taken or administered concurrently in different dosage amounts and at different times. Further, the present invention provides increased and enhanced functionality over prior art devices, including voice play back, voice recognition, reminder transmission within a communications network, and reminder signal output selection.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A medicament reminder device for reminding patients to ingest or administer medicaments, said medicament reminder device comprising:
an input assembly allowing a user to input a plurality of pieces of information directly associated respectively with the medicaments, and a plurality of reminder moments each associated with at least one of the medicaments and the pieces of information corresponding to said at least one of the medicaments;
an output assembly operable to generate a reminder signal, and to generate messages of the pieces of information associated respectively with the medicaments; and
a timer electrically coupled to said output assembly and operable to store the reminder moments, said timer controlling said output assembly at each of said reminder moments to generate said reminder signal, and to generate the messages with respect to the pieces of information corresponding to said at least one of the medicaments;
said timer prompting the user through the output assembly to input the pieces of information and the reminder moments through the input assembly.

2. The medicament reminder device of claim 1, wherein a prescription period is associated with each of the medicaments, said timer discontinuing control of said output assembly to generate said reminder signal and the message associated with the piece of information with respect to any one of the medicaments for which the prescription period has elapsed.

3. The medicament reminder device of claim 2, wherein said input assembly allows the user to input the prescription periods associated with the medicaments.

4. The medicament reminder device of claim 3, wherein said input assembly includes a voice recording unit.

5. The medicament reminder device of claim 4, wherein said voice recording unit is operable to record a user's voice with respect to the messages of the pieces of information associated with the medicaments, and said output assembly is operable to play back the recorded messages.

6. The medicament reminder device of claim 3, wherein said input assembly includes a voice recognition unit for allowing user input to be performed vocally.

7. The medicament reminder device of claim 1, wherein said output assembly includes a display unit.

8. The medicament reminder device of claim 1, further comprising a receptacle for accommodating the medicaments.

9. The medicament reminder device of claim 8, wherein said output assembly and said timer have one of a fixed and detachable relation with said receptacle.

10. The medicament reminder device of claim 1, further comprising a holder for releasably securing a package containing the medicaments to said medicament reminder device.

11. The medicament reminder device of claim 10, wherein said holder includes an elastic strip.

12. The medicament reminder device of claim 1, further comprising a communications assembly operable to transmit a transmission signal to a predetermined terminal within a communications network so as to effect generation of said reminder signal by the predetermined terminal.

13. The medicament reminder device of claim 12, wherein said communications assembly is further operable to transmit corresponding ones of the messages to the predetermined terminal within the communications network.

14. The medicament reminder device of claim 12, wherein the communications network is a telecommunications network.

15. The medicament reminder device of claim 12, wherein the communications assembly utilizes a mobile communications access technology to transmit said reminder signal.

16. The medicament reminder device of claim 1, wherein said output assembly is operable to generate said reminder signal in the form of at least one of an auditory signal, a visual signal, and a vibratory signal.

17. The medicament reminder device of claim 1, wherein said timer controls said output assembly to repeatedly output said reminder signal until acknowledgement is received from a user.
